(19) United States
(12) Patent Application Publication
(10) Pub. No.: US 2026/0179511 A1
(43) Pub. Date: Jun. 25, 2026

(54) LIGHT GUIDE PLATE AND EMERGENCY LIGHT COMPRISING THE SAME

(71) Applicant: Je Woo Corporation, Ltd., Huizhou (CN)

(72) Inventors: Chenggen LI, Huizhou (CN); Huashui CHEN, Huizhou (CN)

(21) Appl. No.: 19/177,615

(22) Filed: Apr. 13, 2025

(30) Foreign Application Priority Data
Dec. 19, 2024 (CN) 202423150031.3

(51) Int. Cl. G09F 13/04; G09F 13/18

(52) U.S. Cl. CPC G09F 13/049; G09F 13/0413; G09F 13/0422; G09F 13/0481; G09F 2013/05; G09F 2013/185

(57) ABSTRACT

A light guide plate including a light guide casing and a reflective layer. The light guide casing includes a first surface, a second surface, and four side surfaces; the first surface is disposed opposite to the second surface; the four side surfaces are connected to the first surface and the second surface; one of the four side surfaces is defined as an incident side oriented towards a light source. The reflective layer is disposed on end faces of the light guide casing but not on the incident side. The light guide casing includes a transparent material. The first surface includes an indicator sign; the indicator sign includes a plurality of ridges. The plurality of ridges are arranged in parallel and protrude from the first surface. The plurality of ridges extend in a direction perpendicular to the incident side.

### CROSS-REFERENCE TO RELATED APPLICATIONS

Pursuant to 35 U.S.C.§ 119 and the Paris Convention Treaty, this application claims foreign priority to Chinese Patent Application No. 202423150031.3 filed Dec. 19, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of emergency lighting, and more particularly, to a light guide plate and an emergency light comprising the same.

Emergency lights are critical for providing directional indicators and emergency illumination. The emergency light is typically equipped with a sign or indicator information to guide the direction of emergency exit paths.

Conventionally, the indicator information of the emergency lights is either applied to the light guide plate using a film or printed onto the light guide plate through silk screening. These methods require the use of additional raw materials and involve multiple processing steps, with relatively low production efficiency. Moreover, films and silk-screened prints are susceptible to peeling over time due to environmental factors, which adversely affects the service life of the emergency light.

### SUMMARY

To solve the aforesaid problems, one objective of the disclosure is to provide a light guide plate.

The light guide plate comprises a light guide casing and a reflective layer.

The light guide casing comprises a first surface, a second surface, and four side surfaces; the first surface is disposed opposite to the second surface; the four side surfaces are connected to the first surface and the second surface; one of the four side surfaces is defined as an incident side oriented towards a light source.

The reflective layer is disposed on end faces of the light guide casing but not on the incident side.

The light guide casing comprises a transparent material; the first surface comprises an indicator sign; the indicator sign comprises a plurality of ridges; the plurality of ridges are arranged in parallel and protrude from the first surface; the plurality of ridges extend in a direction perpendicular to the incident side.

In a class of this embodiment, the light guide casing further comprises a groove disposed on the first surface; the groove comprises a bottom surface; the indicator sign is disposed within the groove and protrude from the bottom surface.

In a class of this embodiment, the height of the plurality of ridges protruding from the bottom surface is less than or equal to a depth of the groove, ensuring that a reflective light is confined within the groove.

In a class of this embodiment, each of the plurality of ridges has a rectangular cross-section.

In a class of this embodiment, each of the plurality of ridges has a width between 0.2 mm and 1 mm.

In a class of this embodiment, the distance between every two adjacent ridges is between 0.5 m and 1 mm.

In a class of this embodiment, the light guide casing is in the shape of a rectangle, and the incident side is a long side of the light guide casing.

In a class of this embodiment, the light guide casing comprises two arc-shaped corners opposite the incident side.

In a class of this embodiment, the light guide casing comprises acrylic.

Another objective of the disclosure is to provide an emergency light. The emergency light comprises a light source and the light guide plate. The emission direction of the light source is oriented towards the incident side of the light guide plate.

The plurality of ridges are disposed on the first surface of the light guide casing. Upon receiving the light, the plurality of ridges reflect the light and exhibit a glowing effect, thereby displaying indicator information. Compared to conventional methods such as attachment or silk screening, the plurality of ridges are less susceptible to environmental damage and are not easy to fall off, thus effectively enhancing the service life of the emergency light.

### BRIEF DESCRIPTION OF THE DRAWINGS

FIG. 1 is a perspective view of a light guide plate according to one embodiment of the disclosure;

FIG. 2 is an enlarged view of the part A in FIG. 1; and

FIG. 3 is a perspective view of an emergency light according to one embodiment of the disclosure.

In the drawings, the following reference numbers are used: 10. Emergency light; 100. Light guide plate; 110. Light guide casing; 120. Reflective layer; 111. Incident side; 130. Indicator sign; 131. Ridge; 112. Groove; 113. Bottom surface; 200. Housing.

### DETAILED DESCRIPTION

To further illustrate the disclosure, embodiments detailing a light guide plate and an emergency light comprising the same are described below. It should be noted that the following embodiments are intended to describe and not to limit the disclosure.

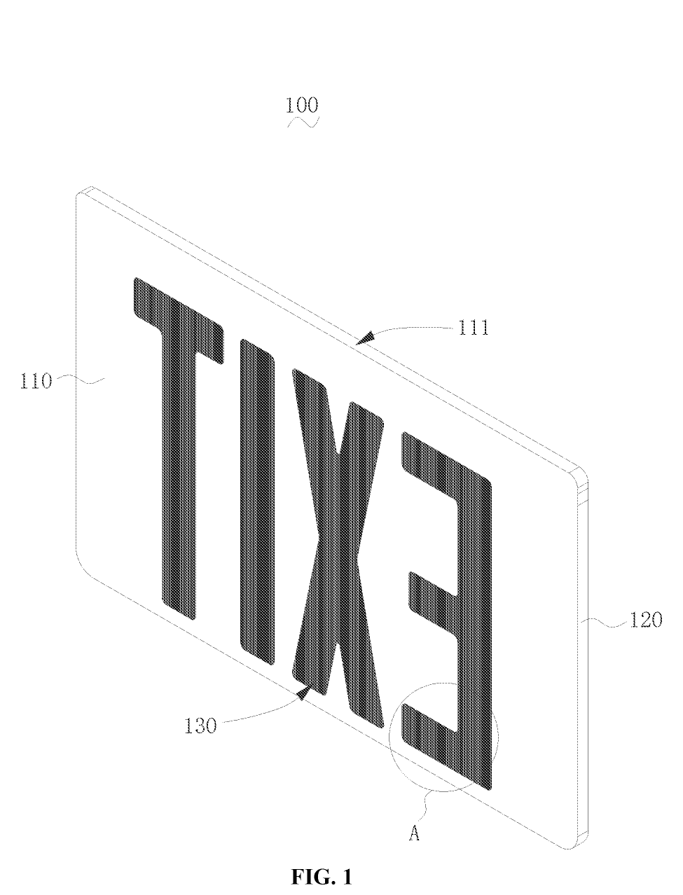

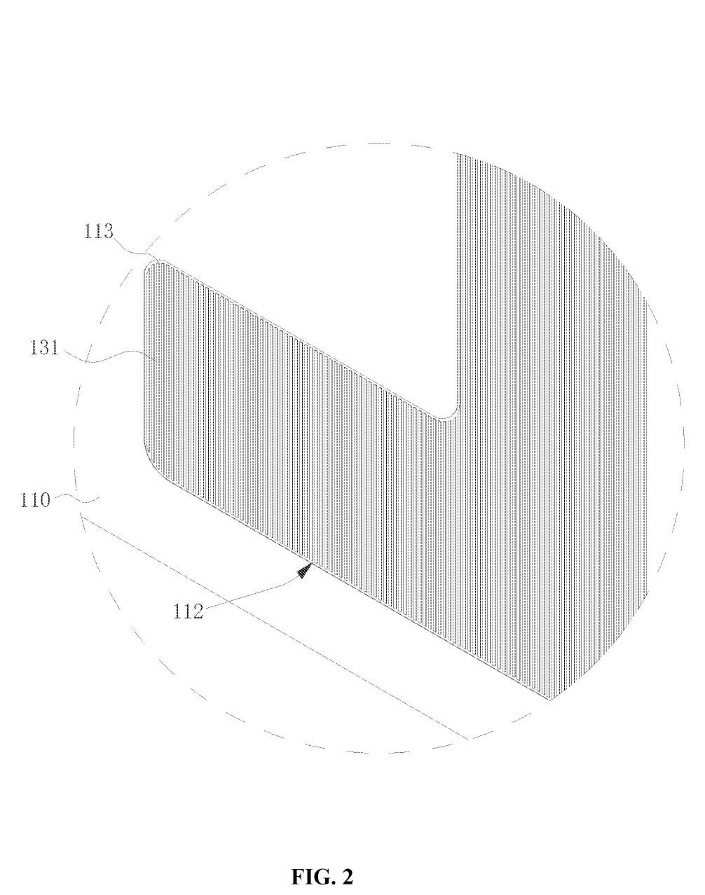

As shown in FIGS. 1 and 2, a light guide plate 100 comprises a light guide casing 110 and a reflective layer 120. The light guide casing 110 comprises a first surface, a second surface, and four side surfaces. The first surface is disposed opposite to the second surface. The four side surfaces are connected to the first surface and the second surface. One of the four side surfaces is defined as an incident side 111 oriented towards a light source. The incident side is configured to allow light from the light source to enter the light guide plate 100.

The reflective layer 120 is disposed on end faces of the light guide casing 110 but not on the incident side 111.

The light guide casing 110 comprises a transparent material. The first surface of the light guide casing 110 comprises an indicator sign 130; the indicator sign comprises a plurality of ridges 131 arranged in parallel and protrude from the first surface of the light guide casing 110. The plurality of ridges 131 are configured to reflect the light. Additionally, the plurality of ridges 131 extend in a direction perpendicular to the incident side 111.

In this embodiment, the light from the light source enters the light guide casing 110 through the incident side 111. The transparent material of the light guide casing 110 allows the light to pass through. The reflective layer 120 comprises an opaque material configured to reflect the light within the light guide casing 110. In one embodiment, the reflective layer 120 is a reflective film, and the reflective film is coated onto the end faces of the light guide casing 110 but not on the incident side 111. In one embodiment, the reflective layer is a sheet of reflective paper.

Specifically, the incident side is disposed near the light source, and the emission direction of the light source is oriented towards the incident side 111 of the light guide plate. The light from the light source enters the light guide casing 110 through the incident side 111 and is reflected by the reflective layer 120, concentrating the light towards the center of the first surface of the light guide casing 110. In this embodiment, the first surface is the largest surface area of the light guide casing 110. The plurality of ridges are configured to reflect the light in various directions and direct the light outward from the light guide casing 110. As a result, the indicator sign 130 exhibits a glowing effect, serving as an indicator. As shown in FIG. 1, the plurality of ridges 131 are arranged to form the word “EXIT”. The light emitted by the light source enters the light guide casing 110 through the incident side 111 and is reflected by the plurality of ridges 131, causing the word “EXIT” to appear as a glowing emergency exit indicator.

In this embodiment, the plurality of ridges 131 extend in a direction perpendicular to the incident side, hereinafter referred to as vertical ridges. The configuration ensures that the plurality of ridges 131 are aligned parallel to the incident direction of the light emitted by the light source, facilitating uniform light diffusion and improving the glowing effect. In practical applications, the plurality of ridges 131 are disposed parallel to the incident side, referred to as horizontal ridges. The horizontal ridges exhibit a gradual decrease in reflecting brightness as the horizontal ridges extends away from the light source. The decrease occurs because the horizontal ridges partially obstruct the propagation of the light, leading to uneven light diffusion and suboptimal glowing effects. However, in the embodiment, the use of the vertical ridges directs the light along the propagation path and reflects the light in a direction perpendicular to the light propagation, thereby avoiding obstruction and eliminating the brightness reduction caused by the horizontal ridges, resulting in improved reflection effect.

The indicator sign 130 is formed integrally with the light guide casing 110 through an injection molding process. Alternatively, the indicator sign 130 is formed by cutting or polishing the light guide casing 110. In this manner, the indicator sign 130 is directly formed on the light guide casing 110 during the manufacturing process, eliminating the subsequent steps such as attachment or silk screening. The direct formation method reduces the number of process steps, increases production efficiency, and results in a more durable structure.

In this embodiment, upon receiving the light, the indicator sign 130 reflects the light and exhibits a glowing effect, thereby displaying indicator information. Compared to conventional methods such as attachment or silk screening, the indicator sign 130 is less susceptible to environmental damage and is not easy to fall off, thereby effectively enhancing the service life of the emergency light 10.

In one embodiment, as shown in FIG. 2, the light guide casing 110 further comprises a groove 112 disposed on the first surface. The groove 112 comprises a bottom surface 113. The plurality of ridges 131 are disposed within the groove 112 and are supported by and protrude from the bottom surface 113.

In this embodiment, the groove 112 is disposed on the first surface of the light guide casing 110 to form the word “EXIT”. The plurality of ridges 131 are disposed within the groove 112 to reflect the light from various directions, ensuring that the reflected light is concentrated on the first surface of the light guide casing 110. The groove 112 is configured to control the height of the plurality of ridges 131. When the plurality of ridges 131 protrude too high, the reflection is spaced at a long distance from the first surface, thereby reducing the intensity of the reflected light. Alternatively, the groove comprises a sidewall used to reflect the light. The sidewall improves the reflection effect of the “EXIT” pattern, making the indication clearer and more distinct.

In one embodiment, the height of the plurality of ridges 131 protruding from the bottom surface 113 is less than or equal to a depth of the groove 112, such that the reflective light is confined within the groove 112. The configuration prevents the formation of a high reflection position that results in weak reflected light intensity. Consequently, the glowing effect is improved on the first surface of the light guide casing 110.

In one embodiment, as shown in FIG. 2, each of the plurality of ridges 131 has a rectangular cross-section. The rectangular cross-section ensures that at least one side of each of the plurality of ridges is parallel to the first surface of the light guide casing 110. The configuration results in a more effective glowing effect for the indicator sign 130.

In one embodiment, each of the plurality of ridges 131 has a cross-sectional shape selected from triangular, circular, or polygonal.

In one embodiment, each of the plurality of ridges 131 has a width between 0.2 mm – 1 mm, and a distance between every two adjacent ridges 131 is between 0.5 m – 1 mm. Preferably, each of the plurality of ridges 131 has a width of 0.5 mm, and a distance between every two adjacent ridges 131 is 0.5 mm. The arrangement allows for uniform reflection of the light reflected by the reflective layer 120. The reflected light is then dispersed outward from the light guide casing 110, resulting in an enhanced glowing effect.

In one embodiment, as shown in FIG. 2, the light guide casing 110 is in the shape of a rectangle. The incident side 111 is a long side of the light guide casing 110. The configuration effectively increases the area available for light incidence and provides additional support for the light guide casing 110.

In one embodiment, as shown in FIG. 2, the light guide casing 110 comprises two arc-shaped corners opposite the incident side 111. The two arc-shaped corners enhance the reflection of the light, directing the light toward a central part of the indicator sign 130, thereby improving the glowing effect.

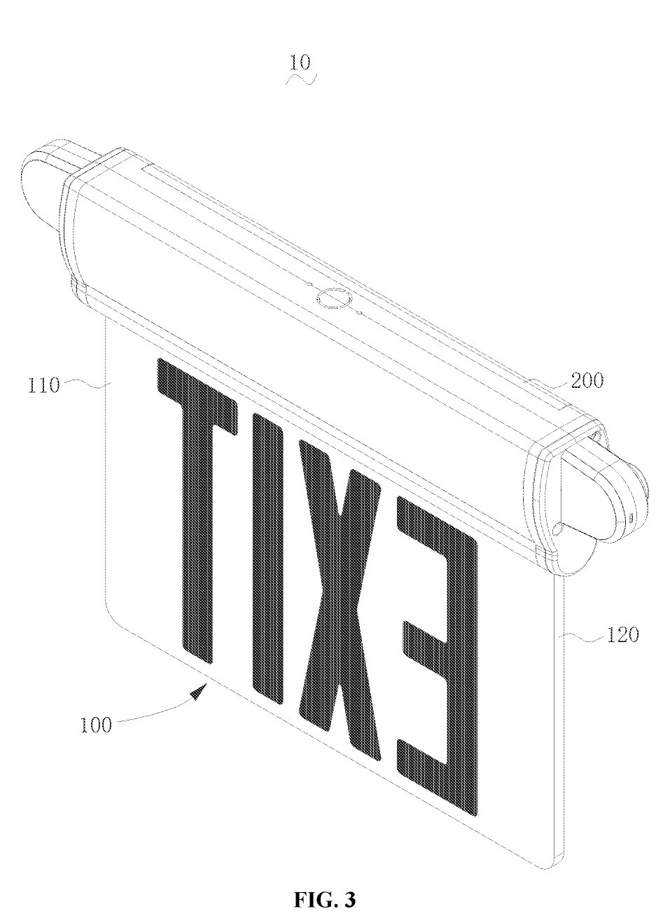

In one embodiment, as shown in FIG. 3, the light guide casing 110 comprises acrylic. Acrylic is light-weight, high-hardness, transparent, and light-transmitting, making it well-suited for reflecting the light and creating an enhanced glowing effect.

In one embodiment, as shown in FIG. 3, an emergency light 10 comprises a light source and the light guide plate 100 as described in any one of the embodiments above. The emission direction of the light source is oriented towards the incident side 111 of the light guide plate. In this embodiment, the emergency light further comprises a housing 200 configured to support the light source, a light board, and a transformer. The housing 200 is fixed to a ceiling or wall indoors through methods such as suspension, screwing, or clipping. The light source is an incandescent lamp or an LED (Light-Emitting Diode) lamp. For example, the light source comprises a light board and at least one LED chip disposed on the light board. The emission direction of the at least one LED chip is oriented towards the incident side 111 of the light guide casing 110.

The light source is disposed within the housing 200. The housing 200 comprises an opening. The incident side 111 of the light guide casing 110 is inserted into and fixed within the opening. The emission direction of the light source faces the incident side 111 of the light guide casing 110. The arrangement ensures that the light emitted from the light source is concentrated toward the incident side 111 of the light guide casing 110.

It will be obvious to those skilled in the art that changes and modifications may be made, and therefore, the aim in the appended claims is to cover all such changes and modifications.

What is claimed is:

1. A light guide plate, comprising:
a light guide casing; and
a reflective layer;
wherein:
the light guide casing comprises a first surface, a second surface, and four side surfaces; the first surface is disposed opposite to the second surface; the four side surfaces are connected to the first surface and the second surface; one of the four side surfaces is defined as an incident side oriented towards a light source;
the reflective layer is disposed on end faces of the light guide casing but not on the incident side; and
the light guide casing comprises a transparent material; the first surface comprises an indicator sign; the indicator sign comprises a plurality of ridges; the plurality of ridges are arranged in parallel and protrude from the first surface; and the plurality of ridges extend in a direction perpendicular to the incident side.

2. The light guide plate of claim 1, wherein the light guide casing further comprises a groove disposed on the first surface; the groove comprises a bottom surface for supporting the plurality of ridges; the plurality of ridges are disposed within the groove and protrude from the bottom surface.

3. The light guide plate of claim 1, wherein a height of the plurality of ridges protruding from the bottom surface is less than or equal to a depth of the groove.

4. The light guide plate of claim 1, wherein each of the plurality of ridges has a rectangular cross-section.

5. The light guide plate of claim 1, wherein each of the plurality of ridges has a width between 0.2 mm and 1 mm.

6. The light guide plate of claim 5, wherein a distance between every two adjacent ridges is between 0.5 m and 1 mm.

7. The light guide plate of claim 1, wherein the light guide casing is in the shape of a rectangle, and the incident side is a long side of the light guide casing.

8. The light guide plate of claim 7, wherein the light guide casing comprises two arc-shaped corners opposite the incident side.

9. The light guide plate of claim 1, wherein the light guide casing comprises acrylic.

10. An emergency light, comprising a light source and the light guide plate of claim 1, wherein an emission direction of the light source is oriented towards the incident side of the light guide plate.
